(19) United States
(12) Patent Application Publication
(10) Pub. No.: US 2008/0266049 A1
(43) Pub. Date: Oct. 30, 2008

(54) Active Distribution Device in a Subscriber Connection Area

(75) Inventor: Jorg Franzke, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 11/914,680

(22) PCT Filed: May 11, 2006
(86) PCT No.: PCT/EP2006/004419

§ 371 Date: Jul. 20, 2008

(30) Foreign Application Priority Data
May 18, 2005 (DE) 10 2005 022 689 2

(51) Int. Cl. H04Q 1/18

(52) U.S. Cl. 340/2.2

(57) ABSTRACT

The invention relates to an active distribution device (1) in the subscriber access area, comprising a multi-service access node (2) which has one interface to a switching center and at least two interfaces to a distribution device, with a first message service being provided via the at least one first interface (7) to the distribution device (3), and a second message service being provided via the at least one second interface (8), the first and/or second interfaces (7, 8) being connected to the distribution device (3), in which the distribution device (3) comprises a changeover device (11) and a switching matrix (12), the first interfaces (7) are connected to first inputs (13) of the changeover device (11), at least the second interfaces (8) are connected to inputs (18) of the switching matrix (12), with the number of inputs (18) of the switching matrix (12) being less than the number of inputs (13) of the changeover device (11), the outputs (15) of the switching matrix (12) being connected to second inputs (14) of the changeover device (11), with the number of first and second inputs (13, 14) of the changeover device (11) being equal, it being possible to adjust the positions of the changeover device (11) and of the switching matrix (12) by a controller so that one output (16) of the changeover device (11) can selectively be connected to one of the first inputs (13) or to one of the second inputs (14), with a second input (14), which is connected to an output (16) of the changeover device (11), being connected to an input (18) of the switching matrix (12).

The invention relates to an active distribution device in the subscriber access area.

Recently, efforts have increasingly been made to move processes which involve complex circuitry out of switching centers and to carry them out closer to the subscriber end, particularly since the large numbers of services and providers are rising sharply. One approach to this is the provision of active distribution devices (Cross Connect Cabinets CCC) in the subscriber access area. These comprise, for example, a multi-service access node (MSAN) with a distribution device connected downstream. The input end of the multi-service access node usually receives broadband data from different services via at least one glass-fiber cable. These services include, for example, ISDN and XDSL services, in addition to POTS (Plain Old Telephone Service). The broadband signal on the glass-fiber cable is then multiplexed onto individual service channels by means of an add/drop matrix. Corresponding electronic cards are used here, and represent an interface to the subordinate distribution device. In this case, one card usually provides a plurality of channels via one interface. This interface is in the form of a multipole plug connector, for example. To assist understanding, the individual pins are each considered to be an interface. The output end of the multi-service access node then provides a number of first and second interfaces or channels, for example n POTS channels and m XDSL channels. The interfaces then provide a connection to the distribution device, where jumpering to the subscriber lines is then carried out. If the distribution device is a manual distribution board, the jumpering also has to be altered manually when the service is changed. In contrast, local changes within the same service can be performed automatically by the MSAN. However, since a service may be changed relatively frequently and at will, manual jumpering constitutes a relatively labour-intensive and time consuming factor.

One possibility for solving this problem would be the use of an automatic remote-controlled distribution device, where each input of the distribution device can be connected to each output, for example. In this way, it is also possible to change the service automatically, without manual jumpering. One disadvantage of automatic distribution devices is that they are relatively expensive and, secondly, are relatively difficult to upgrade. The latter means that the device can respond only inadequately to increasing requirements for channels.

The invention is therefore based on the technical problem of providing an active distribution device in the subscriber access area which can be modularly upgraded in a cost-effective and simple manner.

This technical problem is solved by the object having the features of claim 1. Further advantageous refinements of the invention can be found in the subclaims.

To this end, the active distribution device in the subscriber access area comprises a multi-service access node which has one interface to a switching center and at least two interfaces to a distribution device, with a first message service being provided via the at least one first interface to the distribution device, and a second message service being provided via the at least one second interface, the first and/or second interfaces being connected to the distribution device, and the distribution device comprising a changeover device and a switching matrix, the first interfaces being connected to first inputs of the changeover device, at least the second interfaces being connected to inputs of the switching matrix, with the number of inputs of the switching matrix being less than the number of inputs of the changeover device, the outputs of the switching matrix being connected to second inputs of the changeover device, with the number of first and second inputs of the changeover device being equal, it being possible to adjust the positions of the changeover device and of the switching matrix by a controller so that one output of the changeover device can be selectively connected to one of the first inputs or to one of the second inputs, with a second input, which is connected to an output of the changeover device, being connected to an input of the switching matrix. In this case, the number of first interfaces is preferably equal to the number of channels or subscribers to be switched. The advantage of the invention is that only a simple changeover device and a switching matrix, which, if required, can be modularly upgraded in a simple manner or can be easily replaced, are required for automatically changing a service. In this case, the services which are transmitted via the first interfaces may be regarded as basic services (for example POTS) and the services which are transmitted via the second interfaces may be seen as enhanced services (for example XDSL). The invention now has a basic configuration in which a basic service of this type can be provided to each subscriber by all of the first interfaces being connected to the first inputs of the changeover device, with the first inputs being switched-through to the outputs. If a subscriber then wants an enhanced service, its associated changeover element in the changeover device is connected to the second input of the changeover device, which second input can then provide the enhanced service. In the process, the active distribution device can be easily matched to requirements by replacing the switching matrix. If, for example, the original switching matrix was an 8×32 matrix, this can be easily replaced by a 16×32 switching matrix and twice as many subscribers can take advantage of an enhanced service. One further advantage of the active distribution device according to the invention is that the MSAN can furthermore switch the subscribers within the service, that is to say the functionality is fully utilized and not redundantly represented in the distribution device, as would be the case in an automatic distribution device.

In one preferred embodiment, the changeover device is formed by relays which are preferably in the form of bistable changeover relays. Relays have the advantage of good transmission characteristics along with high reliability. However, other devices, such as microelectronic or micromechanical switches, are also possible.

In one further preferred embodiment, the outputs of the changeover device are connected to a test matrix which itself may be a constituent part of the active distribution device. For example, access can then be made in one or both directions (upstream and downstream) by means of the test matrix. Depending on the design of the test matrix, permanent monitoring or else simultaneous access to two lines in one direction is also possible, in order to measure crosstalk for example.

In one further preferred embodiment, the test matrix is formed by relays which are preferably in the form of monostable relays, so that they change to a basic state, which does not interrupt normal operation, when the supply voltage fails.

In one further preferred embodiment, the multi-service access node comprises third interfaces via which a third message service is provided and which are connected to the inputs of a special-service matrix, it optionally being possible to connect individual outputs of the special-service matrix to the inputs of the switching matrix or matrices. In this way, it is possible to incorporate very specific, rarely required services into the system in a very simple manner and then to distribute these services between various switching matrices. In this case, the changeover is preferably carried out by the same controller as for the changeover device and the switching matrix. The controller which controls the changeover is preferably a controller for the MSAN.

In one further preferred embodiment, the distribution device is arranged in a separate housing.

Electrical connection elements for the first and second interfaces are preferably arranged on one end face of the housing, and electrical connection elements for the outputs of the changeover device are preferably arranged on the opposite end face. This produces a clear separation between the input side to the MSAN and the subscriber-end output side, even in three-dimensions.

In one further preferred embodiment, the electrical connection elements for the first interfaces and the outputs of the changeover device are in the form of multipole plug connectors, so that the connections can be made very easily using prefabricated cables.

In one further preferred embodiment, the electrical connection element for the second interfaces is in the form of a plug connector on the printed equipment card edge, comprising contact elements which, on the side facing the printed equipment card, have a fork contact and an insulation-displacement terminal contact which is accessible from the outside.

In one further preferred embodiment, a further plug connector is provided, by means of which the supply voltage and/or the control signals for the changeover device and the switching matrix and/or a test bus for the test matrix can be connected.

The invention is explained in greater detail below with reference to a preferred exemplary embodiment. In the figures:

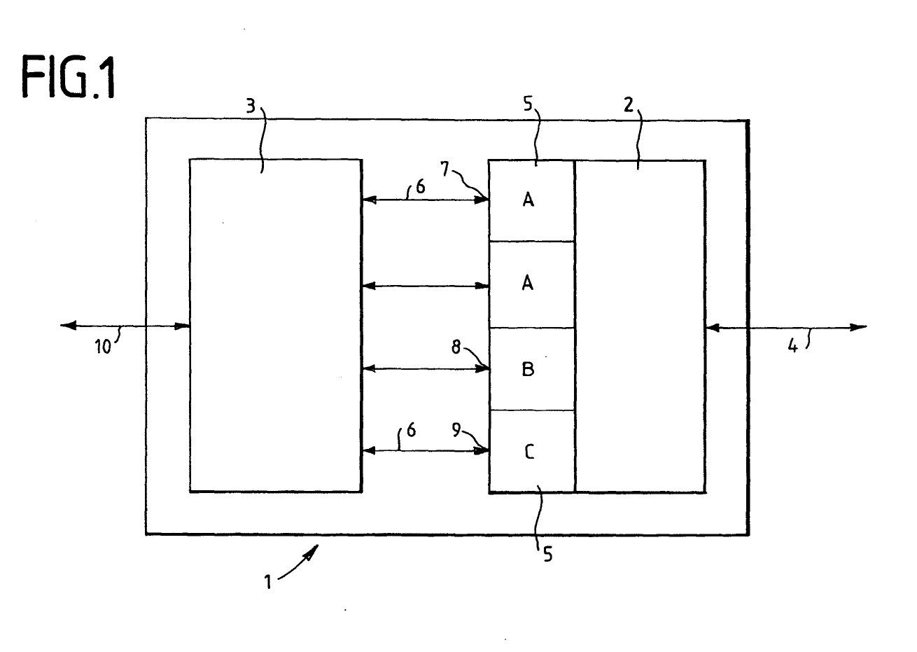

FIG. 1 shows a schematic layout of an active distribution device (prior art),

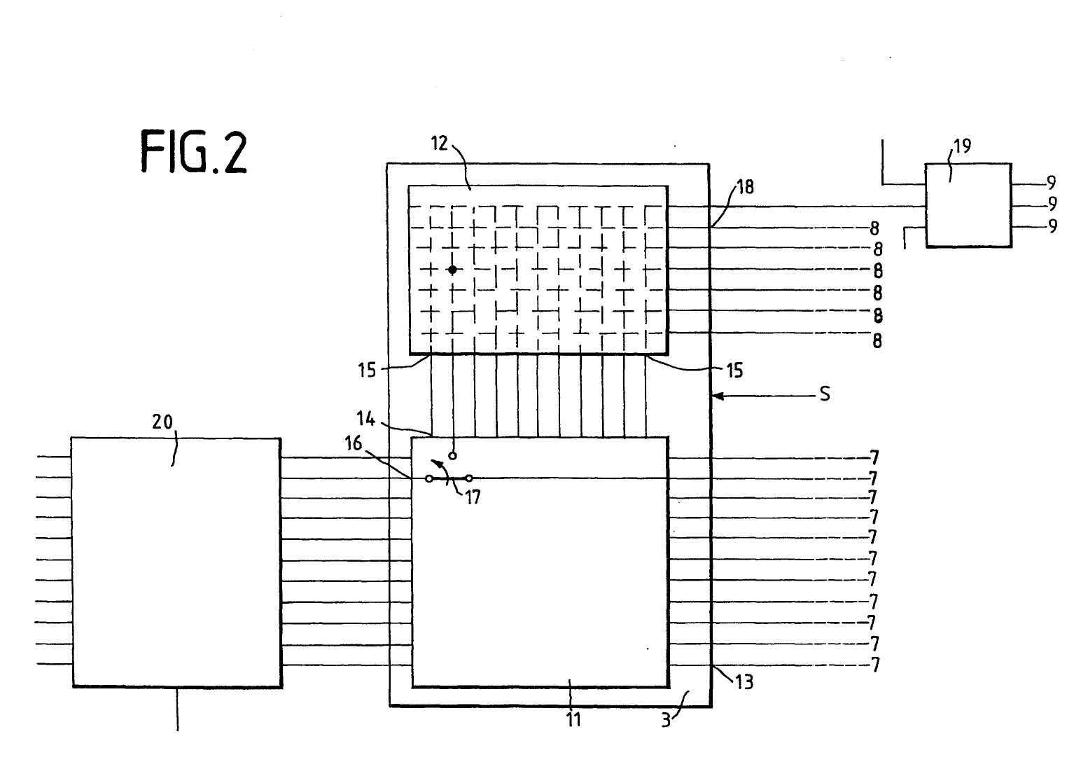

FIG. 2 shows a perspective layout of a distribution device according to the invention,

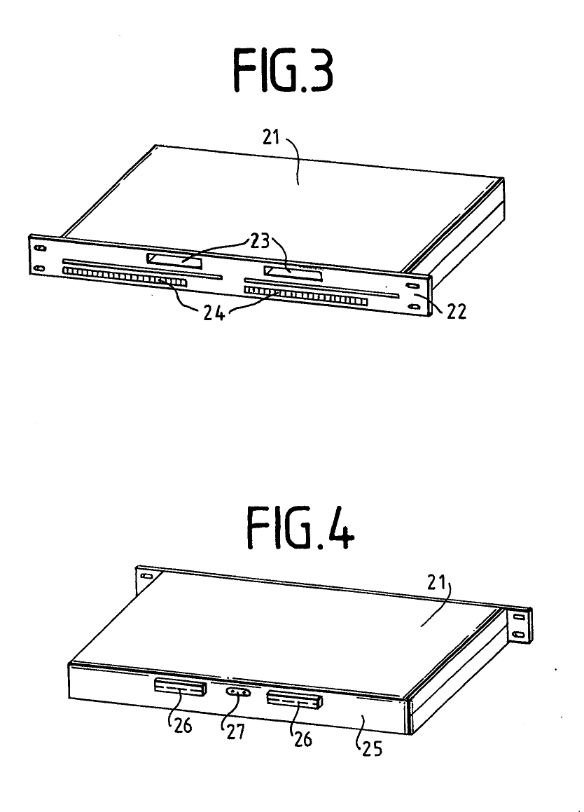

FIG. 3 shows a perspective front view of a housing of the distribution device, and

FIG. 4 shows a perspective rear view of the housing.

FIG. 1 illustrates the basic layout of an active distribution device 1 comprising a multi-service access node 2 and a distribution device 3. One or more glass-fiber cables 4 are typically fed to the input end of the multi-service access node 2, and the optical signals of these glass-fiber cables are then converted to electrical signals by means of an add/drop matrix (not illustrated) and split, with the add/drop matrix being controlled by a controller. The various services provided via the glass-fiber cable 4 are separated during this splitting. It is assumed here that three different services A, B and C are provided. It is assumed here that service A is a combined POTS/ADSL signal, service B is a VDSL signal, and service C is a further XDSL signal. The separated signals for the different services are then conditioned for forwarding to the distribution device 3 by means of line cards 5. In this case, the number of line cards 5 for each service is generally very different. Interfaces which then make an electrical connection, for example via electrical cables 6 or wires, to the distribution device 3 are located at the output of the line cards 5. In this case, the interfaces of the line cards 5 of the service A are called first interface 7, the interfaces of the line cards 5 of the service B are called second interface 8, and the interfaces of the line cards 5 of the service C are called third interface 9. The interfaces on the line cards are usually in the form of multipole sockets by means of which all of the interfaces of one line card 5 can then be tapped off via a plug connector. The controller (not illustrated) is in this case able to change the allocation of the channels on a line card 5. The electrical cables 6 or wires are then terminated at the distribution device 3 and jumpered within the distribution device 3. The output ends of the electrical channels for the subscribers are then passed to the subscribers via an electrical cable 10 which is preferably in the form of an outdoor cable.

FIG. 2 schematically illustrates the distribution device 3 according to the invention. The distribution device comprises a changeover device 11 and a switching matrix 12. In this case, the changeover device 11 has first inputs 13 which are connected to the first interfaces 7 of the first service A. The number of first inputs 13 here corresponds to the number of subscribers to be supplied. The outputs 15 of the switching matrix 12 are applied to the second inputs 14 of the changeover device 11, with the number of first inputs 13 being equal to the number of second inputs 14 and equal to the number of outputs 15 of the switching matrix 12. A first and a second input are associated with a common output 16 of the changeover device 11 here, it being possible to optionally connect the first or the second input to the output 16 by means of changeover elements 17. FIG. 2 schematically illustrates one single such changeover element 17 which is preferably in the form of a bistable relay. Second interfaces 8 of the second service B and interfaces 9 of the third service C are connected to the inputs 18 of the switching matrix 12, the said interfaces 9 being distributed between various distribution devices 3 by means of a special-service matrix 19. In this case, the number of inputs 18 of the switching matrix 12 is less than the number of outputs 15. The switching matrix 12 is designed in such a way here that each input 18 can be connected to each output 15, as is illustrated for one input/output pair by the bold dot. It should be noted here that the special-service matrix 19 is preferably a balanced matrix. In the illustrated exemplary embodiment, the outputs 16 of the changeover device 11 are furthermore connected to the inputs of a test matrix 20, but this will not be explained in any greater detail here.

In the basic state of the distribution device 3, all of the changeover elements 17 are switched in such a way that the first inputs 13 are connected to the outputs 16, that is to say each subscriber receives service A. If a subscriber then decides that he wants service B, the configuration can be changed by means of a controller signal S. For this purpose, the associated changeover element 17 of the subscriber is switched so that the second input 14 is now connected to the output 16. At the same time, in the switching matrix 12, the associated output 15 of the switching matrix is connected to an unused input 18 of the switching matrix. It is thus possible to automatically change over to enhanced services in a very simple manner. The percentage of subscribers who can take advantage of an enhanced service depends on the ratio of inputs 18 to outputs 15 of the switching matrix 12. If all of the possible inputs 18 are switched-through, the distribution device 3 can be easily upgraded by replacing the switching matrix 12 with a larger one which has more inputs 18. Furthermore, the active distribution device 1 can be easily upgraded for a larger number of subscribers by connecting a plurality of distribution devices 3 in parallel.

FIGS. 3 and 4 illustrate a housing 21 of a distribution device 3. Two multipole plug connectors 23 for the first interfaces 7 (see FIG. 2) and a plurality of plug connectors 24 on the printed equipment card edge for the second and third interfaces 8, 9 are arranged on the front end face 22. In this case, the plug connectors 23 represent the inputs 13 of the changeover device 11, and the plug connectors 24 represent the inputs 18 of the switching matrix 12. Two multipole plug connectors 26 are arranged on the opposite end face 25 and represent the outputs 16 of the changeover device 11 or, when integrated in the housing 21, represent the test matrix 20. The supply voltage and the control signals S are fed to the distribution device 3 by means of a second plug connector 27.

### LIST OF REFERENCE SYMBOLS

1 Distribution device
2 Multi-service access node
3 Distribution device
4 Glass-fiber cable
5 Line card
6 Electrical cable
7 First interface
8 Second interface
9 Third interface
10 Electrical cable
11 Changeover device
12 Switching matrix
13 First inputs
14 Second inputs
15 Output
16 Output
17 Changeover element
18 Input
19 Special-service matrix
20 Test matrix
21 Housing
22 Front end face
23 Plug connector
24 Plug connector
25 Opposite end face
26 Plug connector
27 Plug connector
S Control signal

1. An active distribution device in the subscriber access area, comprising a multi-service access node which has one interface to a switching center and at least two interfaces to a distribution device, with a first message service being provided via the at least one first interface to the distribution device, and a second message service being provided via the at least one second interface, the first and/or second interfaces being connected to the distribution device,
wherein
the distribution device comprises a changeover device and a switching matrix, the first interfaces are connected to first inputs of the changeover device, at least the second interfaces are connected to inputs of the switching matrix, with the number of inputs of the switching matrix being less than the number of inputs of the changeover device, the outputs of the switching matrix are connected to second inputs of the changeover device, with the number of first and second inputs of the changeover device being equal, it being possible to adjust the positions of the changeover device and of the switching matrix by a controller so that one output of the changeover device can be selectively connected to one of the first inputs or to one of the second inputs, with a second input, which is connected to an output of the changeover device, being connected to an input of the switching matrix.

2. The active distribution device as claimed in claim 1, wherein the changeover device is formed by relays.

3. The active distribution device as claimed in claim 2, wherein the relays are in the form of bistable changeover relays.

4. The active distribution device as claimed in claim 1, wherein the outputs of the changeover device are connected to a test matrix.

5. The active distribution device as claimed in claim 4, wherein the test matrix comprises monostable changeover relays.

6. The active distribution device as claim 1, wherein the multi-service access node comprises third interfaces via which a third message service is provided and which are connected to the inputs of a special-service matrix, it optionally being possible to connect individual outputs of the special-service matrix to inputs of the switching matrix or matrices.

7. The active distribution device as claimed in claim 1, wherein the distribution device is arranged in a separate housing.

8. The active distribution device as claimed in claim 7, wherein electrical connection elements for the first and second interfaces are arranged on one end face of the housing, and electrical connection elements for the outputs of the changeover device are arranged on the opposite end face.

9. The active distribution device as claimed in claim 8, wherein the electrical connection elements for the first interfaces and the outputs of the changeover device are in the form of multipole plug connectors.

10. The active distribution device as claimed in claim 8, wherein the electrical connection element for the second interfaces is in the form of a plug connector on the printed equipment card edge, comprising contact elements which, on the side facing the printed equipment card, have a fork contact and an insulation-displacement terminal contact which is accessible from the outside.

11. The active distribution device as claimed in claim 8, wherein a further plug connector is provided, by means of which the supply voltage and/or the control signals for the changeover device and the switching matrix and/or a test bus for the test matrix can be connected.

12. An active distribution device in the subscriber access area, comprising a multi-service access node which has one interface to a switching center and at least two interfaces to a distribution device, with a first message service being provided via the at least one first interface to the distribution device, and a second message service being provided via the at least one second interface, the first and/or second interfaces being connected to the distribution device,
wherein
the distribution device comprises a changeover device and a switching matrix, the first interfaces are connected to first inputs of the changeover device, at least the second interfaces are connected to inputs of the switching matrix, the outputs of the switching matrix are connected to second inputs of the changeover device, with the number of first and second inputs of the changeover device being equal, it being possible to adjust the positions of the changeover device and of the switching matrix by a controller so that one output of the changeover device can be selectively connected to one of the first inputs or to one of the second inputs, with a second input, which is connected to an output of the changeover device, being connected to an input of the switching matrix.

13. A telecommunications apparatus comprising:
a switching matrix including a plurality of matrix inputs and a plurality of matrix outputs, the switching matrix being configured such that any one of the switching inputs can be electrically connected to any one of the matrix outputs; and
a changeover arrangement including a plurality of first input locations and a plurality of second input locations, the plurality of first input locations being electrically connected to the matrix outputs, the changeover arrangement also including a plurality of changeover switches, each of the changeover switches being electrically connected to a changeover output, the changeover switches being movable to first positions where the changeover outputs are electrically connected to the first input locations and electrically disconnected from the second input locations, and the changeover switches being movable to second positions where the changeover outputs are electrically connected to the second input locations and electrically disconnected from the first input locations.
